(19) United States
(12) Patent Application Publication
(10) Pub. No.: US 2023/0143687 A1
(43) Pub. Date: May 11, 2023

(54) METHOD OF ESTIMATING THREE-DIMENSIONAL COORDINATE VALUE FOR EACH PIXEL OF TWO-DIMENSIONAL IMAGE, AND METHOD OF ESTIMATING AUTONOMOUS DRIVING INFORMATION USING THE SAME

(71) Applicant: MOBILTECH, Seoul (KR)

(72) Inventors: Jae Seung KIM, Goyang-Si, Gyeonggi-do (KR); Do Yeong IM, Gwangmyeong-si, Gyeonggi-do (KR)

(21) Appl. No.: 17/282,925

(22) PCT Filed: Nov. 20, 2020
(86) PCT No.: PCT/KR2020/016486

§ 371 Date: Jan. 4, 2023

(30) Foreign Application Priority Data
Dec. 6, 2019 (KR) 10-2019-0161567

(51) Int. Cl. G06T 7/73; G06T 5/00; G06V 20/70; G06V 20/58

(52) U.S. Cl. CPC G06T 7/75; G06T 5/006; G06V 20/70; G06V 20/58; G06T 2207/30261; G06T 2207/30244; G06V 2201/08

(57) ABSTRACT

Proposed are a method of estimating a three-dimensional coordinate value for each pixel of a two-dimensional image, and a method of estimating autonomous driving information using the same, and more specifically, a method that can efficiently acquire information needed for autonomous driving using a mono camera. This method is able to acquire information having sufficient reliability in real-time without using expensive equipment such as a high-precision GPS receiver, a stereo camera or the like required for autonomous driving.

### TECHNICAL FIELD

The present invention relates to a method of estimating a three-dimensional coordinate value for each pixel of a two-dimensional image, and a method of estimating autonomous driving information using the same, and more specifically, to a method that can efficiently acquire information needed for autonomous driving using a mono camera.

The present invention relates to a method of estimating a three-dimensional coordinate value for each pixel of a two-dimensional image, and a method of estimating autonomous driving information using the same, which can acquire information having sufficient reliability in real-time without using expensive equipment such as a high-precision GPS receiver, a stereo camera or the like required for autonomous driving.

### BACKGROUND ART

Unmanned autonomous driving of a vehicle (autonomous vehicle) largely includes the step of recognizing a surrounding environment (cognitives domain), the step of planning a driving route from the recognized environment (determination domain), and the step of driving along the planned route (control domain).

Particularly, in the case of the cognitive domain, it is a basic technique performed first for autonomous driving, and techniques in the next steps of the determination domain and the control domain can be accurately performed only when the technique in the cognitive domain is performed accurately.

The technique of the cognitive domain includes a technique of identifying an accurate location of a vehicle using GPS, and a technique of acquiring information on a surrounding environment through image information acquired through a camera.

First, in autonomous driving, the error range of GPS about the location of a vehicle should be smaller than the width of a lane, and although the smaller the error range, the more efficiently it can be used for real-time autonomous driving, a high-precision GPS receiver with such a small error range is expensive inevitably.

As one of techniques for solving the problem, ‘Positioning method and system for autonomous driving agricultural unmanned tractor using multiple low-cost GPS’ (hereinafter, referred to as ‘prior art 1’) disclosed in Korean Patent Publication No. 10-1765746, which is a prior art document, may secure precise location data using a plurality of low-cost GPSs by complementing a plurality of GPS location information with each other based on a geometric structure.

However, in the prior art 1, since a plurality of GPS receivers should operate, it is natural that the cost is subject to increase as much as the number of GPS receivers.

In addition, since a plurality of GPS receivers needs to be interconnected, the configuration of the devices and the data processing processes are inevitably complicated, and the complexity may work as a factor that lowers reliability of the devices.

Next, as a technique for obtaining information on the surrounding environment, ‘Automated driving method based on stereo camera and apparatus thereof’ (hereinafter referred to as ‘prior technology 2’) disclosed in Korean Patent Publication No. 10-2018-0019309, which is a prior art document, adjusts a depth measurement area by adjusting the distance between two cameras constituting a stereo camera according to driving conditions of a vehicle (mainly, the driving speed).

As described above, the technique using a stereo camera also has a problem similar to that of the cited invention 1 described above since the device is expensive and accompanied with complexity of device configuration and data processing.

In addition, in a technique like the cited invention 2, the accuracy depends on the amount of image-processed data. However, since the amount of data should be reduced for real-time data processing, there is a disadvantage in that the accuracy is limited.

(Patent Document 0001) Korean Patent Publication No. 10-1765746 ‘Positioning method and system for autonomous driving of agricultural unmanned tractor using multiple low-cost GPS’

(Patent Document 0002) Korean Laid-opened Patent Publication No. 10-2018-0019309 ‘Automated driving method based on stereo camera and apparatus thereof’

### DISCLOSURE OF INVENTION

### Technical Problem

Therefore, the present invention has been made in view of the above problems, and it is an object of the present invention to provide a method of estimating a three-dimensional coordinate value for each pixel of a two-dimensional image, and a method of estimating autonomous driving information using the same, which can efficiently acquire information needed for autonomous driving using a mono camera.

More specifically, an object of the present invention is to provide a method of estimating a three-dimensional coordinate value for each pixel of a two-dimensional image, and a method of estimating autonomous driving information using the same, which can estimate a relative location of an object (vehicle, etc.) required for autonomous driving and semantic information (lane, etc.) for autonomous driving in real-time by estimating a three-dimensional coordinate value for each pixel of an image captured by a mono camera, using modeling by a pinhole camera model and linear interpolation.

In addition, more specifically, an object of the present invention is to provide a method of estimating a three-dimensional coordinate value for each pixel of a two-dimensional image, and a method of estimating autonomous driving information using the same, which can acquire information having sufficient reliability in real-time without using expensive equipment such as a high-precision GPS receiver, a stereo camera or the like required for autonomous driving.

### Technical Solution

To accomplish the above objects, according to one aspect of the present invention, there is provided a method of estimating a three-dimensional coordinate value for each pixel of a two-dimensional image, the method comprising: a camera height input step of receiving height of a mono camera installed in parallel to ground; a reference value setting step of setting at least one among a vertical viewing angle, an azimuth angle, and a resolution of the mono camera; and a pixel coordinate estimation step of estimating a three-dimensional coordinate value for at least some of pixels with respect to ground of the two-dimensional image captured by the mono camera, based on the inputted height of the mono camera and a set reference value.

In addition, the pixel coordinate estimation step may include a modeling process of estimating the three-dimensional coordinate value by generating a three-dimensional point using a pinhole camera model.

In addition, the pixel coordinate estimation step may further include, after the modeling process, a lens distortion correction process of correcting distortion generated by a lens of the mono camera.

In addition, the method of estimating a three-dimensional coordinate value may further comprise, after the pixel coordinate estimation step, a non-corresponding pixel coordinate estimation step of estimating a three-dimensional coordinate value of a pixel that is not corresponding to the three-dimensional coordinate value among the pixels of the two-dimensional image from a pixel corresponding to the three-dimensional coordinate value using a linear interpolation method.

In addition, there is provided a method of estimating autonomous driving information using a method of estimating a three-dimensional coordinate value for each pixel of a two-dimensional image, the method comprising: a two-dimensional image acquisition step of acquiring the two-dimensional image captured by a mono camera; a coordinate system matching step of matching each pixel of the two-dimensional image and a three-dimensional coordinate system; and an object distance estimation step of estimating a distance to an object included in the two-dimensional image.

In addition, the coordinate system matching step includes the method of estimating a three-dimensional coordinate value for each pixel of a two-dimensional image described above, and the object distance estimation step may include an object location calculation process of confirming the object included in the two-dimensional image, and estimating a direction and a distance to the object based on the three-dimensional coordinate value corresponding to each pixel.

In addition, at the object location calculation step, a distance to a corresponding object may be estimated using a three-dimensional coordinate value corresponding to a pixel corresponding to the ground of the object included in the two-dimensional image.

In addition, there is provided a method of estimating autonomous driving information using a method of estimating a three-dimensional coordinate value for each pixel of a two-dimensional image, the method comprising: a two-dimensional image acquisition step of acquiring the two-dimensional image captured by a mono camera; a coordinate system matching step of matching each pixel of the two-dimensional image and a three-dimensional coordinate system; and a semantic information location estimation step of estimating a three-dimensional coordinate value of semantic information for autonomous driving included in the ground of the two-dimensional image.

In addition, the coordinate system matching step includes the method of estimating a three-dimensional coordinate value for each pixel of a two-dimensional image of claim 4, and may further include, after the semantic information location estimation step, a localization step of confirming a location of a corresponding vehicle on a HD-map for autonomous driving based on the three-dimensional coordinate value of semantic information for autonomous driving.

In addition, the localization step may include: a semantic information confirmation process of confirming corresponding semantic information for autonomous driving on the HD-map for autonomous driving; and a vehicle location confirmation process of confirming a current location of the vehicle on the HD-map for autonomous driving by applying a relative location with respect to the semantic information for autonomous driving.

### Advantageous Effects

By the solutions described above, the present invention has an advantage of efficiently acquiring information needed for autonomous driving using a mono camera.

More specifically, the present invention has an advantage of estimating a relative location of an object (vehicle, etc.) required for autonomous driving and semantic information (lane, etc.) for autonomous driving in real-time by estimating a three-dimensional coordinate value for each pixel of an image captured by a mono camera, using modeling by a pinhole camera model and linear interpolation.

Particularly, when only the captured image is used simply, an object in the image is recognized through image processing, and a distance to the object is estimated. At this point, since the amount of data to be processed increases significantly as the accuracy of required distance increases, there is a limit in processing the data in real-time.

Contrarily, since a three-dimensional coordinate value for each pixel is estimated based on the ground of a captured image, the present invention has an advantage of minimizing the data needed for image analysis and processing the data in real-time.

Accordingly, the present invention has an advantage of acquiring information having sufficient reliability in real-time without using expensive equipment such as a high-precision GPS receiver, a stereo camera or the like required for autonomous driving.

In addition, the present invention has an advantage of significantly reducing data processing time compared with expensive high-definition LiDAR that receives millions of points per second.

In addition, since LiDAR data measured as a vehicle moves has an error according to the relative speed and an error generated due to shaking of the vehicle, the accuracy also decreases, whereas since a two-dimensional image in a static state (captured image) and three-dimensional relative coordinates match each other, the present invention has an advantage of high accuracy.

In addition, together with the disadvantage of being limited since calculation of a distance using the depth of a stereo camera may estimate the distance through a pixel that can be distinguished from the surroundings, such as a feature point or a boundary of an image, it is difficult to express an accurate value since it is calculation of a distance using triangulation, whereas since the present invention is a technique of estimating a three-dimensional coordinate value based on the ground, there is an advantage of calculating a distance within a considerably reliable error range.

As described above, the present invention can be widely used for an advanced driver assistance system (ADAS), localization or the like for the purpose of estimation of a current location of an autonomous vehicle, calculation of a distance between vehicles or the like through recognition of objects and semantic information for autonomous driving without using GPS, and furthermore has an advantage of developing a camera that can perform the same function by developing software using corresponded data.

Accordingly, reliability and competitiveness can be enhanced in the fields of autonomous driving, object recognition for autonomous driving, and autonomous vehicle location tracking, as well as in the similar or related fields.

### BRIEF DESCRIPTION OF THE DRAWINGS

FIG. 1 is a flowchart illustrating an embodiment of a method of estimating a three-dimensional coordinate value for each pixel of a two-dimensional image according to the present invention.

FIGS. 2 to 4 are views for describing each step of FIG. 1 in detail.

FIG. 5 is a flowchart illustrating another embodiment of FIG. 1.

FIG. 6 is a flowchart illustrating an embodiment of a method of estimating autonomous driving information using a method of estimating a three-dimensional coordinate value for each pixel of a two-dimensional image according to the present invention.

FIGS. 7 and 8 are views describing step S300 shown in FIG. 3.

FIGS. 9 to 12 are views describing step S400 shown in FIG. 3.

FIG. 13 is a flowchart illustrating another embodiment of a method of estimating autonomous driving information using a method of estimating a three-dimensional coordinate value for each pixel of a two-dimensional image according to the present invention.

FIGS. 14 and 15 are views describing FIG. 13.

FIG. 16 is a flowchart illustrating yet another embodiment of a method of estimating autonomous driving information using a method of estimating a three-dimensional coordinate value for each pixel of a two-dimensional image according to the present invention.

FIGS. 17 and 18 are views describing FIG. 16.

### BEST MODE FOR CARRYING OUT THE INVENTION

Examples of a method of estimating a three-dimensional coordinate value for each pixel of a two-dimensional image, and a method of estimating autonomous driving information using the same according to the present invention may be diversely applied, and hereinafter, a most preferred embodiment will be described with reference to the accompanying drawings.

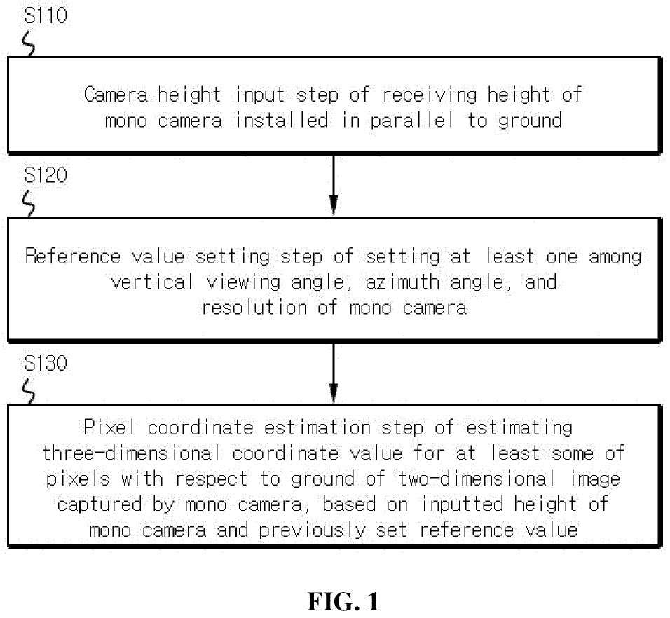

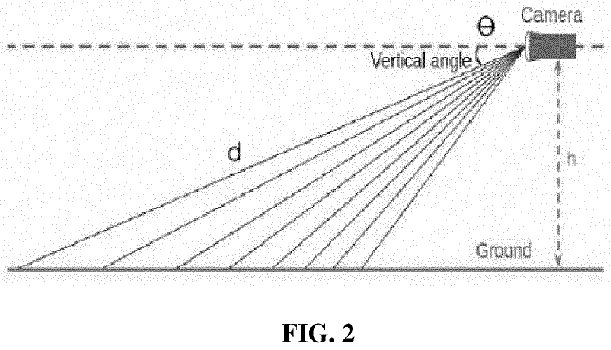

FIG. 1 is a flowchart illustrating an embodiment of a method of estimating a three-dimensional coordinate value for each pixel of a two-dimensional image according to the present invention, and FIGS. 2 to 4 are views for describing each step of FIG. 1 in detail.

Referring to FIG. 1, a method of estimating a three-dimensional coordinate value for each pixel of a two-dimensional image includes a camera height input step (S110), a reference value setting step (S120), and a pixel coordinate estimation step (S130).

The camera height input step (S110) is a process of receiving the height (h) of a mono camera installed in parallel to the ground as shown in FIG. 2, and a driver (user) of a vehicle equipped with the mono camera may input the height, or a distance measurement sensor may be configured on one side of the mono camera to automatically measure the distance to the ground, and in addition, the height of the mono camera may be measured and input in various ways in response to a request of those skilled in the art.

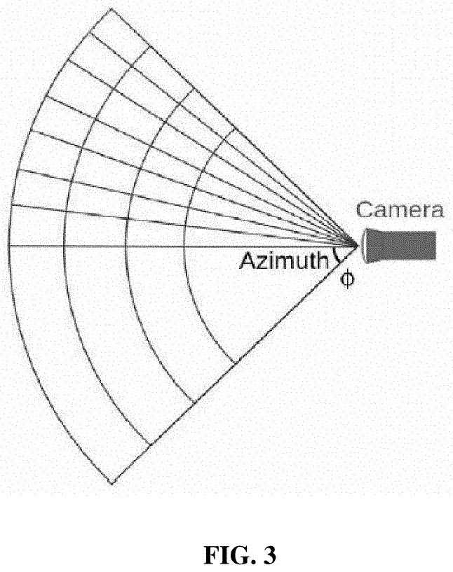

The reference value setting step (S120) is a process of setting at least one among the vertical viewing angle (θ), azimuth angle (φ), and resolution of the mono camera as shown in FIGS. 2 and 3, and it goes without saying that frequently used values may be set in advance or may be input and changed by a user.

The pixel coordinate estimation step (S130) is a process of estimating a three-dimensional coordinate value for at least some of the pixels with respect to the ground of the two-dimensional image captured by the mono camera, based on the inputted height of the mono camera and a previously set reference value, and it will be described below in detail.

First, referring to FIG. 2, the distance d to the ground according to the height h and the vertical viewing angle θ of the mono camera may be expressed as shown in Equation 1.

d=h/sin θ (Equation 1)

In addition, as shown in FIG. 3, three-dimensional coordinates of a three-dimensional point generated on the ground may be determined by the azimuth φ and the resolution. Here, the three-dimensional point is a point displayed on the ground from the viewpoint of the mono camera, and may correspond to a pixel of a two-dimensional image in the present invention.

For example, a three-dimensional point X, Y, and Z with respect to the ground may be expressed as shown in Equation 2 in terms of distance d, height h, vertical viewing angle θ, and the azimuth angle φ of the mono camera.

X=d cos θ sin Ø

Y=d cos θ cos Ø

Z=−h (Equation 2)

Thereafter, a three-dimensional coordinate value may be estimated by generating a three-dimensional point using a pinhole camera model.

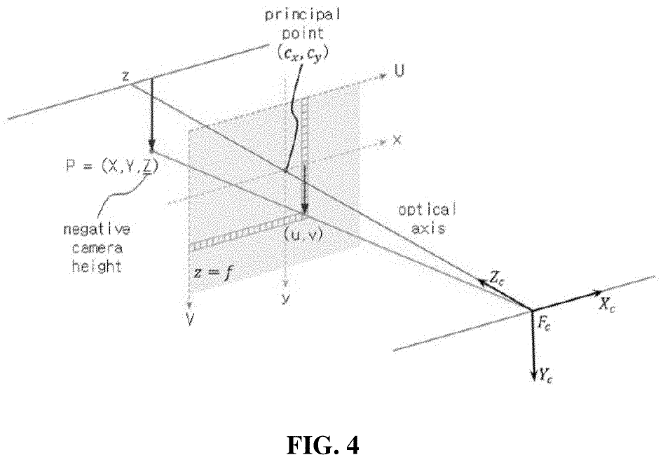

FIG. 4 is a view showing a relation and a corresponding view between the pixel of a two-dimensional image with respect to the ground and a three-dimensional point using a pinhole camera model, and each of the rotation matrixes Rx, Ry and Rz for roll, pitch and yaw may be expressed as in Equation 3.

$${R}_{x} ( α ) = [ \begin{matrix}1 & 0 & 0 \\ 0 & cos α & - sin α \\ 0 & sin α & cos α\end{matrix} ] \\ {R}_{y} ( β ) = [ \begin{matrix}cos β & 0 & sin β \\ 0 & 1 & 0 \\ - sin β & 0 & cos β\end{matrix} ] \\ {R}_{z} ( γ ) = [ \begin{matrix}cos γ & - sin γ0 & 0 \\ sin γ & cos γ & 0 \\ 0 & 0 & 1\end{matrix} ] \qquad ( Equation 3 )$$

In addition, rotation matrix R for transforming the three-dimensional coordinate system of the mono camera's viewpoint into the coordinate system of a two-dimensional image may be expressed as shown in Equation 4.

R=R_{z}(γ)R_{y}(β)Rₓ(α) (Equation 4)

Finally, in order to transform a point X, Y and Z of the three-dimensional coordinate system to a point of a two-dimensional image of the camera's viewpoint, the point of the three-dimensional coordinate system is multiplied by rotation matrix R as shown in Equation 5.

$$[ \begin{matrix}x \\ y \\ z\end{matrix} ] = R [ \begin{matrix}X \\ Y \\ Z\end{matrix} ] \qquad ( Equation 5 )$$

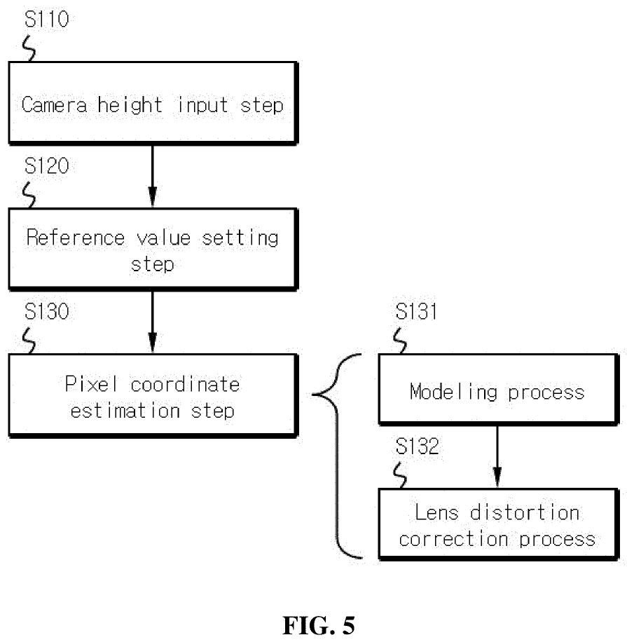

In this way, when the modeling process (S131) shown in FIG. 5 is performed, a lens distortion correction process (S132) of correcting distortion generated by the lens of the mono camera may be performed thereafter.

Generally, since a lens of a camera does not have a perfect curvature, distortion is generated in an image, and in order to estimate an accurate location, calibration for correcting the distortion is performed.

When external parameters of the mono camera are calculated through calibration of the mono camera, radial distortion coefficients k1, k2, k3, k4, k5 and k6 and tangential distortion coefficients p1 and p2 may be obtained.

The process as shown in Equation 6 is developed using the external parameters.

$$\begin{matrix}{x}^{′} = x / z \\ {y}^{′} = y / z \\ {x}^{″} = {x}^{′} \frac{1 + {k}_{1} {r}^{2} + {k}_{2} {r}^{4} + {k}_{3} {r}^{6}}{1 + {k}_{4} {r}^{2} + {k}_{5} {r}^{4} + {k}_{6} {r}^{6}} + 2 {p}_{1} {x}^{′} {y}^{′} + {p}_{2} ( {r}^{2} + 2 {x}^{′2} ) \\ {y}^{″} = {y}^{′} \frac{1 + {k}_{1} {r}^{2} + {k}_{2} {r}^{4} + {k}_{3} {r}^{6}}{1 + {k}_{4} {r}^{2} + {k}_{5} {r}^{4} + {k}_{6} {r}^{6}} + {p}_{1} ( {r}^{2} + 2 {y}^{′ 2} ) + 2 {p}_{2} {x}^{′} {y}^{′}\end{matrix} \qquad ( Equation 6 )$$

$$( here , {r}^{2} = {x}^{′ 2} + {y}^{′ 2} )$$

The relational equations of the image coordinate systems u and v obtained using the two points obtained before, focal lengths fₓ and f_{y}, which are internal parameters of the mono camera, and principal points cx and cy are as shown in Equation 7.

u=fₓ*x″+cₓ

v=f_{y}*y″+c_{y} (Equation 7)

In the process as described above, when the height of the mono camera and the pinhole camera model are used, pixels and three-dimensional points corresponding to the ground may be calculated.

Hereinafter, the process described above will be described using an image actually captured by a mono camera.

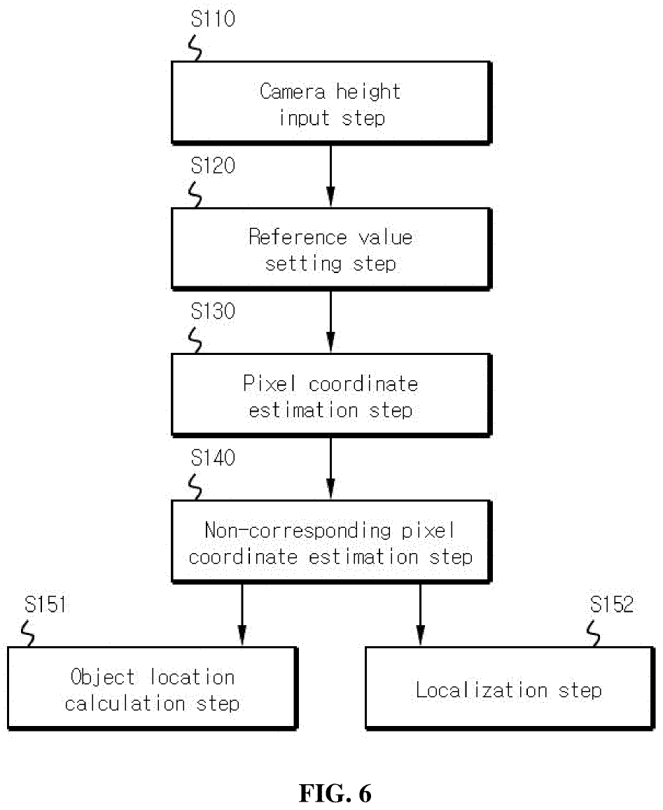

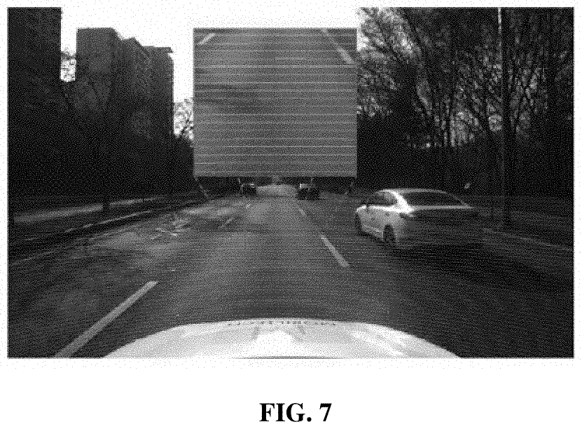

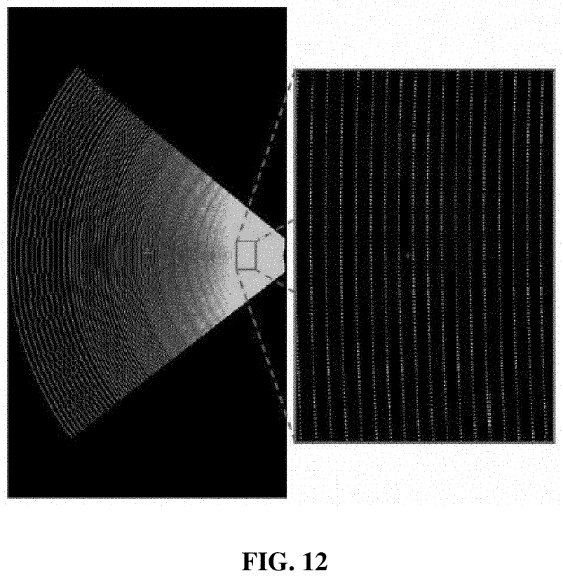

FIG. 6 is a flowchart illustrating an embodiment of a method of estimating autonomous driving information using a method of estimating a three-dimensional coordinate value for each pixel of a two-dimensional image according to the present invention, and FIGS. 7 and 12 are views describing the steps after step S130 shown in FIG. 3.

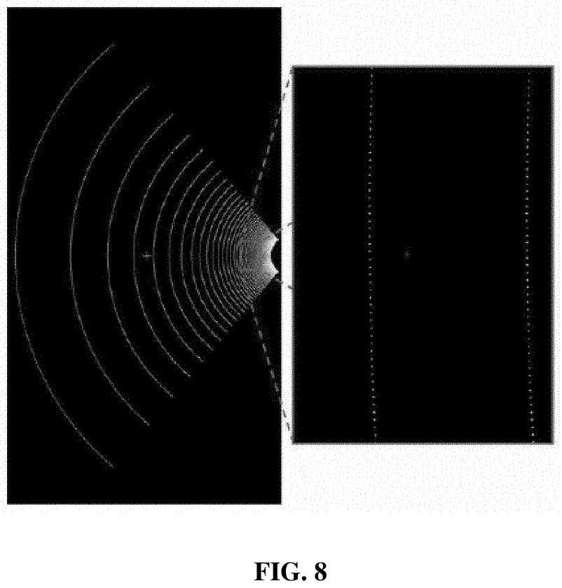

First, FIGS. 7 and 8 are views showing three-dimensional points at the pixels corresponding to the ground of a two-dimensional image through the process described above at the pixel coordinate estimation step (S130). As is understood from the enlarged portion, it can be seen that the spaces between the points are empty.

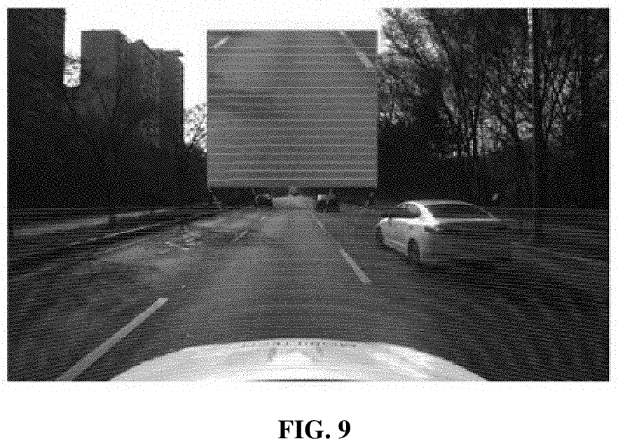

Referring to FIG. 6, when a three-dimensional coordinate value of a pixel that does not correspond to the coordinate value of a three-dimensional point among the pixels of the two-dimensional image is estimated after the pixel coordinate estimation step (S130) from a pixel corresponding to the coordinate value of the three-dimensional point using a linear interpolation method as shown in the enlarged portions of FIGS. 7 and 8 (S140), the three-dimensional point may be displayed as shown in FIGS. 9 to 12.

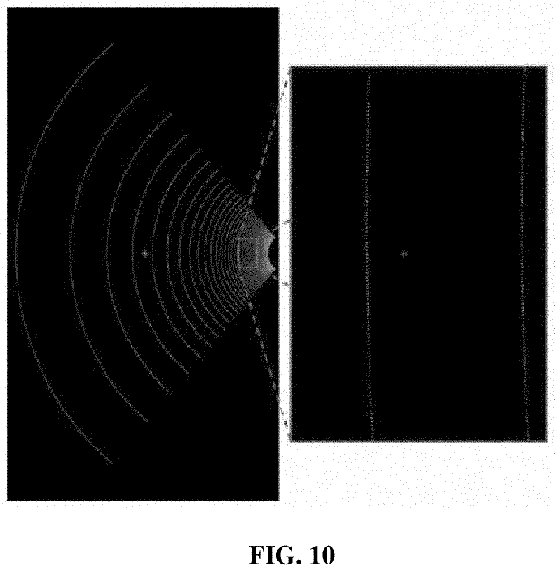

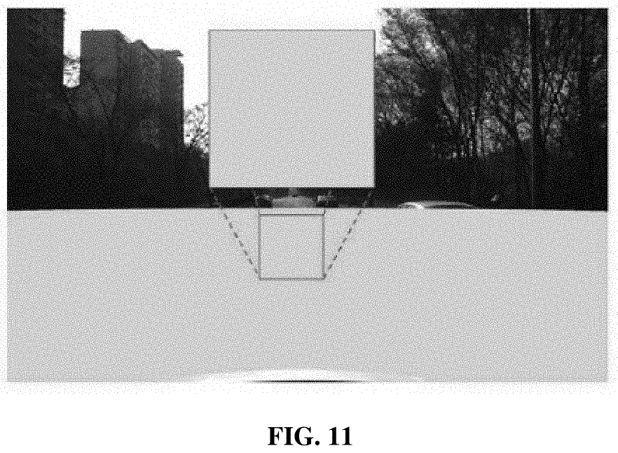

Here, FIGS. 9 and 10 show a view applying the linear interpolation method in the left and right directions, and FIGS. 11 and 12 show a view applying the linear interpolation method in the forward and backward directions after applying the linear interpolation method in the left and right directions.

The data passing through the process may be used at an object location calculation step S151, a localization step S152, and the like, and this will be described below in more detail.

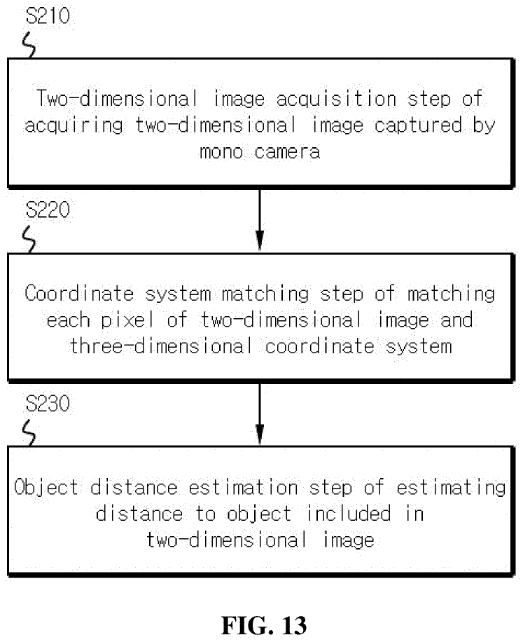

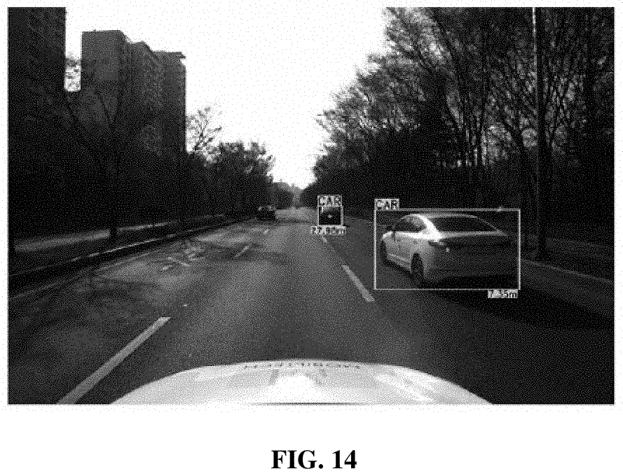

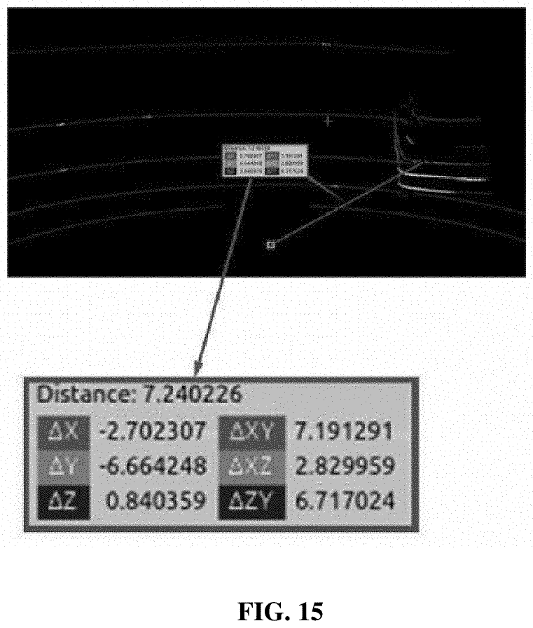

FIG. 13 is a flowchart illustrating another embodiment of a method of estimating autonomous driving information using a method of estimating a three-dimensional coordinate value for each pixel of a two-dimensional image according to the present invention, and FIGS. 14 and 15 are views describing FIG. 13.

Referring to FIG. 13, the method of estimating autonomous driving information according to the present invention includes a two-dimensional image acquisition step (S210), a coordinate system matching step (S220), and an object distance estimation step (S230).

Describing in detail, a two-dimensional image captured by a mono camera is acquired at the two-dimensional image acquisition step (S210), and each pixel of the two-dimensional image and a three-dimensional coordinate system are matched at the coordinate system matching step (S220), and a distance to an object included in the two-dimensional image is estimated at the object distance estimation step (S230).

At this point, the coordinate system matching step (S220) may estimate a three-dimensional coordinate value for each pixel of the two-dimensional image through processes ‘S110’ to ‘S140’ of FIG. 6 described above.

Thereafter, at the object distance estimation step (S230), an object location calculation process of confirming an object (vehicle) included in the two-dimensional image as shown in FIG. 14, and estimating a direction and a distance to the object based on a three-dimensional coordinate value corresponding to each pixel may be performed.

Specifically, at the object location calculation process, a distance to a corresponding object may be estimated using a three-dimensional coordinate value corresponding to a pixel corresponding to the ground (the ground on which the vehicle is located) of the object included in the two-dimensional image.

FIG. 14 is a view showing a distance to a vehicle in front estimated according to the present invention, and as shown in FIG. 14, the distance to the vehicle estimated using the pixels at the lower ends of both sides of the bounding box recognizing the vehicle in front and the width and height of the bounding box is 7.35 m.

In addition, the distance measured using LiDAR in the same situation is about 7.24 m as shown in FIG. 15, and although an error of about 0.11 m with respect to FIG. 14 may occur, when the distance only to the ground on which the object is located is estimated, the accuracy may be further improved.

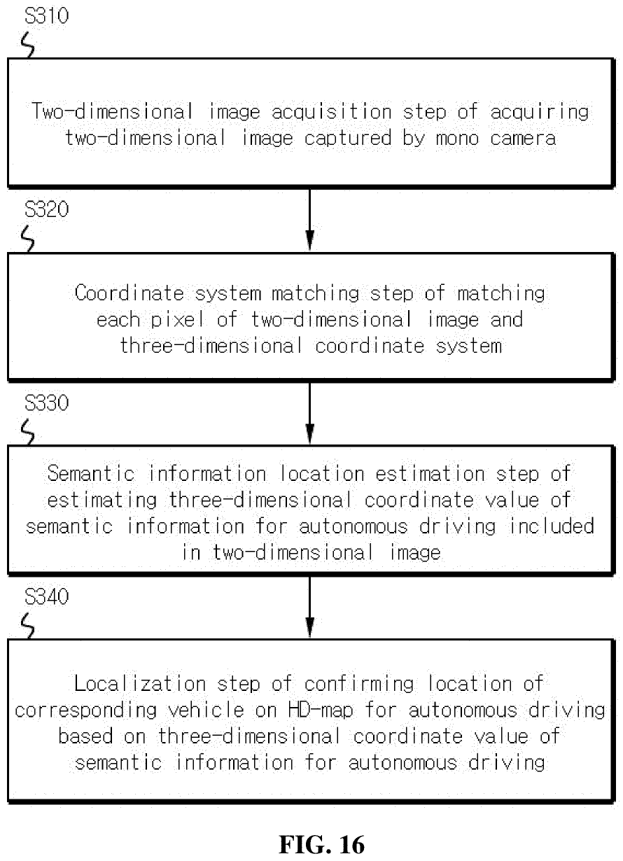

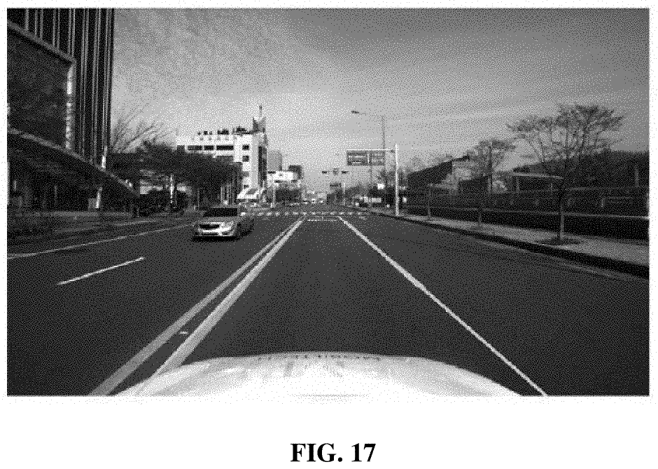

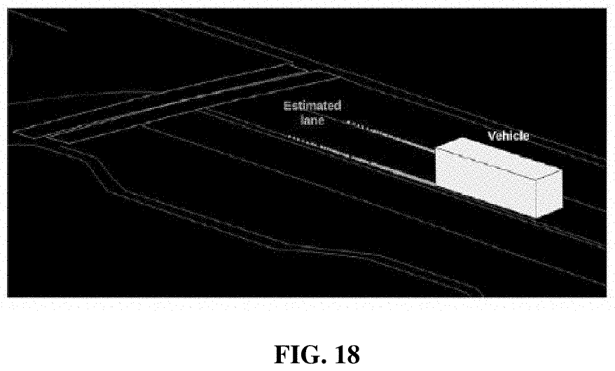

FIG. 16 is a flowchart illustrating another embodiment of a method of estimating autonomous driving information using a method of estimating a three-dimensional coordinate value for each pixel of a two-dimensional image according to the present invention, and FIGS. 17 and 18 are views describing FIG. 16.

Referring to FIG. 16, the method of estimating autonomous driving information according to the present invention includes a two-dimensional image acquisition step (S310), a coordinate system matching step (S320), and a semantic information location estimation step (S330).

Describing in detail, a two-dimensional image captured by a mono camera is acquired at the two-dimensional image acquisition step (S310), and each pixel of the two-dimensional image and a three-dimensional coordinate system are matched at the coordinate system matching step (S320), and a three-dimensional coordinate value of semantic information for autonomous driving included in the ground of the two-dimensional image is estimated at the semantic information location estimation step (S330).

At this point, the coordinate system matching step (S320) may estimate a three-dimensional coordinate value for each pixel of the two-dimensional image through processes ‘S110’ to ‘S140’ of FIG. 6 described above.

In addition, after the semantic information location estimation step (S330), a localization step (S340) of confirming the location of a corresponding vehicle (a vehicle equipped with a mono camera) on a high-definition map (HD-map) for autonomous driving based on the three-dimensional coordinate value of the semantic information for autonomous driving may be further included.

Particularly, the localization step (S340) may perform a semantic information confirmation process of confirming corresponding semantic information for autonomous driving on the HD-map for autonomous driving, and a vehicle location confirmation process of confirming the current location of a vehicle on the HD-map for autonomous driving by applying a relative location with respect to the semantic information for autonomous driving.

In other words, as shown in FIG. 17, when the three-dimensional coordinate value of the semantic information for autonomous driving (e.g., lanes) included in the ground of the two-dimensional image is estimated (S330), as shown in FIG. 18, corresponding semantic information may be confirmed on the HD-map, and the location of a corresponding vehicle (a vehicle equipped with a mono camera) may be grasped using a relative direction and distance with respect to the confirmed semantic information (S340).

A method of estimating a three-dimensional coordinate value for each pixel of a two-dimensional image, and a method of estimating autonomous driving information using the same according to the present invention have been described above. It will be appreciated that those skilled in the art may implement the technical configuration of the present invention in other specific forms without changing the technical spirit or essential features of the present invention.

Therefore, it should be understood that the embodiments described above are illustrative and not restrictive in all respects.

1. A method of estimating a three-dimensional coordinate value for each pixel of a two-dimensional image, the method comprising:
a camera height input step of receiving height of a mono camera installed in parallel to ground;
a reference value setting step of setting at least one among a vertical viewing angle, an azimuth angle, and a resolution of the mono camera; and
a pixel coordinate estimation step of estimating a three-dimensional coordinate value for at least some of pixels with respect to ground of the two-dimensional image captured by the mono camera, based on the inputted height of the mono camera and a set reference value.

2. The method according to claim 1, wherein the pixel coordinate estimation step includes a modeling process of estimating the three-dimensional coordinate value by generating a three-dimensional point using a pinhole camera model.

3. The method according to claim 2, wherein the pixel coordinate estimation step further includes, after the modeling process, a lens distortion correction process of correcting distortion generated by a lens of the mono camera.

4. The method according to claim 1, further comprising, after the pixel coordinate estimation step, a non-corresponding pixel coordinate estimation step of estimating a three-dimensional coordinate value of a pixel that is not corresponding to the three-dimensional coordinate value among the pixels of the two-dimensional image from a pixel corresponding to the three-dimensional coordinate value using a linear interpolation method.

5. A method of estimating autonomous driving information using a method of estimating a three-dimensional coordinate value for each pixel of a two-dimensional image, the method comprising:
a two-dimensional image acquisition step of acquiring the two-dimensional image captured by a mono camera;
a coordinate system matching step of matching each pixel of the two-dimensional image and a three-dimensional coordinate system; and
an object distance estimation step of estimating a distance to an object included in the two-dimensional image.

6. The method according to claim 5, wherein the coordinate system matching step includes the method of estimating a three-dimensional coordinate value for each pixel of a two-dimensional image of claim 4, and the object distance estimation step includes an object location calculation process of confirming the object included in the two-dimensional image, and estimating a direction and a distance to the object based on the three-dimensional coordinate value corresponding to each pixel.

7. The method according to claim 6, wherein at the object location calculation step, a distance to a corresponding object is estimated using a three-dimensional coordinate value corresponding to a pixel corresponding to the ground of the object included in the two-dimensional image.

8. A method of estimating autonomous driving information using a method of estimating a three-dimensional coordinate value for each pixel of a two-dimensional image, the method comprising:
a two-dimensional image acquisition step of acquiring the two-dimensional image captured by a mono camera;
a coordinate system matching step of matching each pixel of the two-dimensional image and a three-dimensional coordinate system; and
a semantic information location estimation step of estimating a three-dimensional coordinate value of semantic information for autonomous driving included in the ground of the two-dimensional image.

9. The method according to claim 8, wherein the coordinate system matching step includes the method of estimating a three-dimensional coordinate value for each pixel of a two-dimensional image of claim 4, and further includes, after the semantic information location estimation step, a localization step of confirming a location of a corresponding vehicle on a HD-map for autonomous driving based on the three-dimensional coordinate value of semantic information for autonomous driving.

10. The method according to claim 9, wherein the localization step includes:
a semantic information confirmation process of confirming corresponding semantic information for autonomous driving on the HD-map for autonomous driving; and
a vehicle location confirmation process of confirming a current location of the vehicle on the HD-map for autonomous driving by applying a relative location with respect to the semantic information for autonomous driving.

11. The method according to claim 2, further comprising, after the pixel coordinate estimation step, a non-corresponding pixel coordinate estimation step of estimating a three-dimensional coordinate value of a pixel that is not corresponding to the three-dimensional coordinate value among the pixels of the two-dimensional image from a pixel corresponding to the three-dimensional coordinate value using a linear interpolation method.

12. The method according to claim 3, further comprising, after the pixel coordinate estimation step, a non-corresponding pixel coordinate estimation step of estimating a three-dimensional coordinate value of a pixel that is not corresponding to the three-dimensional coordinate value among the pixels of the two-dimensional image from a pixel corresponding to the three-dimensional coordinate value using a linear interpolation method.
